(19) United States
(12) Patent Application Publication
(10) Pub. No.: US 2010/0015296 A1
(43) Pub. Date: Jan. 21, 2010

(54) FRUIT-BASED FOOD PRODUCT AND METHOD OF MAKING

(76) Inventor: Richard S. Meyer, Federal Way, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 12/503,301

(22) Filed: Jul. 15, 2009

Related U.S. Application Data
(60) Provisional application No. 61/081,862, filed on Jul. 18, 2008.

(51) Int. Cl. A23L 1/212; A23L 1/00; A23L 1/068; A23P 1/10; A23L 1/0524; A23P 1/08

(52) U.S. Cl. 426/96; 426/102; 426/465; 426/138; 426/523; 426/577; 426/473

(57) ABSTRACT

A food product is provided that is formed from dehydrated fruit to form a crust for pies, wraps, and the like in which the dehydrated fruit has a water activity level in the range of 0.4 to 0.9 Aw. The dehydrated fruit can be ground into particles that are extruded, compressed, rolled, or stamped into a sheet that is cut into top and bottom crusts. Dehydrated fruit particles having a water activity level of 0.1 to 0.2 Aw can be used to form a cracker-like crust. The fruit-based crust can be used to form an all-fruit pie or similar-type pastry.

### BACKGROUND

1. Technical Field

The present disclosure is directed to a food product employing fruit and to a process of preparing the fruit-based product for use as a crust, shell, wrap and the like.

2. Description of the Related Art

A pie is usually defined as a flour-based pastry crust with a fruit filling, the filling generally composed of a cooked starch thickener, sugar, and fruit. While the crust is usually a baked flour-based paste, it can be formed from other food items, such as a combination of brown sugar and nuts, ground graham crackers, and the like.

These known crusts have the disadvantage of requiring complex preparation in that they require the mixing of multiple ingredients and, in some recipes, baking to achieve a crisp or hardened crust. These crusts tend to have a limited shelf life in terms of days, typically use ingredients that have high caloric and fat content, and they can be difficult to handle and store.

Fruit-based foods are generally known. For example, fruit fillings are usually pasteurized and then cooled or allowed to remain hot when added to a wrap, pie shell, or poured onto a bottom crust and covered with a top crust. Depending on the application, the crust for such fruit-filled items must hold the liquid without leaking or breaking apart during or after the preparation process.

There is a need for a substitute for existing crusts and shells that is simplified in the preparation process, is healthier than existing flour-based pastries, and has an extended shelf life.

### BRIEF SUMMARY

The present disclosed embodiments are directed to a fruit-based food product and method of making. In one embodiment, an edible product in the form of a crust or shell is provided that is formed from dehydrated fruit having a water activity (Aw) in the range of 0.4 to 0.9. Ideally, the fruit is dehydrated and ground into particles, each particle having an overall diameter in the range of 0.1 mm to 3.0 mm.

In accordance with another aspect of the foregoing embodiment, the ground dehydrated fruit particles are compressed together using at least one from among extrusion, compression, rolling, and stamping to form a sheet of dehydrated fruit.

In accordance with one embodiment of the present disclosure, a food product is provided that includes a filling, and at least one shell surrounding the filling, the at least one shell formed of dehydrated fruit having a water activity in the range of 0.4 to 0.9 Aw.

In accordance with one aspect of the foregoing embodiment, the at least one shell includes a bottom layer and a top layer with filling between the top layer and the bottom layer. In one embodiment, at least the bottom layer is formed of dehydrated fruit ground into particles having a diameter in the range of 0.1 mm to 3 mm and a water activity level in the range of 0.4 to 0.9 Aw, and more optimally of 0.6 to 0.75 Aw, or a lower 0.1 to 0.2 Aw for a crunchy particle.

In accordance with another aspect of the foregoing embodiment, the at least one shell is formed of multiple layers of sheets of the dehydrated fruit, each sheet having a thickness in the range of 0.1 mm to 1.0 mm. Butter, a plastic shortening, an oil, lecithin, an edible wax (e.g. bees wax) or another layer of fruit with a different water activity can be placed between each sheet of the multiple layers in the shell. This will provide a flakiness to the shell similar to that of flour-based products.

In accordance with another aspect of the foregoing embodiment, the shell can be formed in the shape of a tube that contains the filling.

In accordance with another embodiment of the present disclosure, a method of producing a food product is provided that includes producing a puree of fruit; drying the fruit puree to form a dehydrated fruit having a water activity level in the range of 0.4 to 0.9 Aw; and forming the dehydrated fruit into a sheet having a thickness in the range of 2.0 mm to 6.0 mm.

In accordance with another aspect of the foregoing embodiment, the fruit puree is dried using air-drying. Following the air-drying the dehydrated fruit can be ground into particles having a size in the range of 0.1 mm to 3.0 mm. These ground particles can be extruded, stamped, rolled, or compressed into sheets.

In accordance with another aspect of the foregoing embodiment, the pureed fruit is dried using a vacuum drying after the pureed fruit is heated. Following forming of the dried dehydrated fruit into a sheet, further drying can be done prior to cutting the sheet into a desired shape.

In accordance with another aspect of the foregoing embodiment, the food product includes a filling added in between two layers of the dehydrated fruit sheets to form a pie. Alternatively, the sheet of dehydrated fruit can be wrapped around a filling to form a wrap. The sheet can also be formed as a tube to contain the filling.

In accordance with another aspect of the foregoing embodiment, the pureed fruit can be dried to a water activity level in the range of 0.1 to 0.2 Aw and ground to form crunchy particles that are used to form a cracker-like crust.

In accordance with another aspect of the foregoing embodiment, multiple layers of the sheets of the dehydrated fruit are used to form a flaky crust. To assist in providing flakiness, the adjacent layers of the dehydrated fruit sheets are formed of different water activity levels. Butter, a plastic shortening, lecithin, or an edible wax can also be provided between each of the adjacent sheets of dried fruit.

In accordance with another embodiment of the present disclosure, a fruit-based crust is provided that is formed of dehydrated fruit having a water activity level in the range of 0.4 to 0.9 Aw. The dehydrated fruit is formed of ground dehydrated fruit particles with each particle having a diameter in the range of 0.1 mm to 3.0 mm.

In accordance with another aspect with the foregoing embodiment, the fruit particles are compressed together using at least one from among extrusion, compression, rolling, and stamping, to form a sheet of dehydrated fruit. The sheet can then be cut into desired shapes. Alternatively, the particles are extruded into the form of a tube having a hollow interior to contain a filling.

In accordance with another aspect of the foregoing embodiment, the crust is formed of multiple layers of sheets of dehydrated fruit, thus providing a flakiness to the crust, with adjacent sheets having different levels of water activity, and butter, a plastic shortening, lecithin, or an edible wax formed between adjacent sheets.

In accordance with another embodiment, a fruit-based crust or shell is provided that utilizes fruit concentrate and pectin. The fruit-based shell can be formed into a bottom crust, a top crust, and layered crusts, or it can be shaped using molds. The fruit-based shells may also be formed into sheets that may be rolled or wrapped to encase fruit-based and traditional food-wrap fillings.

In accordance with one embodiment, a fruit-based pie is provided that may be formed by filling the fruit-based shell with fruit-based fillings in accordance with techniques of the present disclosure. Traditional pie fillings can be used with the fruit-based shells. The fruit-based shell filled with the pie filling may be served immediately or packaged or stored by commercially available means, for example, by freezing.

The fruit-based shells can be layered with crusts and sheets formed from the previously described dehydrated fruit shell in accordance with the present disclosure.

In accordance with one embodiment, fruit-based shells are provided from a mixture of fruit juice concentrate and pectin. In one example of the present disclosure, the mixture of pectin and fruit juice concentrate is boiled, poured into a mold, cooled to ambient temperature, and allowed to gel into the desired shell shape. Preferably, the mixture is boiled five minutes, plus or minus 30 seconds. Preferably, 2.4% pectin by weight is used, but the amount can be adjusted within plus or minus 20%. In other words, the plus or minus 20% of the pectin level means 1.92% pectin to the desired level of 2.4% to a higher level of 2.88%; the lower the level, the softer the texture and the higher the level, the stiffer the texture. The range can be more generally stated as 1.9% to 2.9%, and in another embodiment more narrowly as 2.2% to 2.6%. Although the amount of pectin and the time of boiling may be adjusted further, it can affect the quality of the fruit-based shell.

In accordance with the present disclosure, a method of producing a food product is provided that includes: providing a mixture of pectin and at least two fruit juice concentrates, the pectin comprising between 1.9% and 2.9% by weight of the mixture, a first fruit juice concentrate comprising 86% to 96% by weight of the mixture and the remainder of the mixture comprising a first juice concentrate flavoring comprising 2% to 10% by weight of the mixture; boiling the mixture into a boiled mixture; delivering the boiled mixture into a receptacle; and cooling the boiled mixture to ambient temperature. Ideally the mixture is blended for a period of time in the range of 2 to 3 minutes and boiled for a period of time in the range of 3 to 7 minutes.

In accordance with another aspect of the present disclosure, a food product shell formed from a boiled and cooled mixture, the mixture constituting: 1.9% to 2.9% pectin by weight; a fruit juice concentrate flavoring comprising 2% to 10% by weight; and a second fruit juice concentrate comprising 86% to 96% by weight.

Different flavored fruit-based shells can be obtained, for example, by adding flavoring, by blending more than one fruit concentrate, and by adjusting the concentrations of different fruit concentrates and flavoring.

### BRIEF DESCRIPTION OF THE DRAWINGS

The disclosure is explained in further detail, and by way of example, with reference to the accompanying drawings, wherein:

FIG. 1 illustrates examples of food-based products from pectin and a combination of fruit juice concentrates formed in accordance with the present disclosure.

### DETAILED DESCRIPTION

In the following description, certain specific details are set forth in order to provide a thorough understanding of various embodiments of the present disclosure. However, one skilled in the art will understand that the disclosure may be practiced without one or more of these specific details. In other instances, well-known aspects of food products and methods of producing food products such as pies, wraps, burritos, soft-shell tacos, pastry-like shells, and the like have not been described in detail to avoid unnecessarily obscuring the descriptions of the embodiments of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.”

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense to include alternatives and not in the conjunction “and” unless the context clearly dictates otherwise.

Values recited in this specification as a “range” are intended to include the end values noted therein. When values are described as “between” two end values, the end values in this case are not intended to be included.

A pastry crust is usually formed of a flour-based paste that is cooked. The present disclosure provides an alternative type of crust that is entirely fruit based. This fruit-based crust can then be used to form 100% fruit pies, fruit wraps, and other food products. It is to be understood that as used herein the word “crust” is not to be limited to flour-based baked and unbaked pastries that are used to make pies, wraps, and the like. For example, the present disclosure utilizes an all-fruit non-baked ingredient that is formed into an edible “crust” to be used in making products that typically involve flour-based crusts. Moreover, “crust” is intended to include shells, wraps, and the like of any shape or form.

In accordance with one embodiment of the present disclosure, a fruit-based crust is provided that is formed of a dehydrated fruit having a water activity level in the range of 0.4 to 0.9 Aw. An optimum water activity level is generally in the range of 0.6 to 0.75 Aw for most applications. A water activity level of 0.5 Aw generally provides a firm texture whereas a water activity level of 0.9 results in a generally thick and tacky or sludge-like consistency. Different water activity levels are used to achieve a desired consistency for particular food products.

In accordance with the present disclosure, the dehydrated fruit is initially formed using known processes. For example, an air-dried dehydrated fruit is formed from fruit, such as apples or pears, that is processed to separate the skin, seeds, and hard tissues from the remaining fruit to form a creamy fruit puree. This can be accomplished with a through a typical meat deboning machine or similar device. The fruit puree is then air dried at an elevated temperature with flowing air until the target water activity is achieved. As the puree dries it is formed into a sheet of dehydrated fruit.

In order to have a texture suitable for cutting and chewing, the sheet of dehydrated fruit is then ground into particles, with the particles generally having an overall diameter in the range of 0.1 mm to 3.0 mm. The particles of dehydrated fruit are then formed into a sheet and cut into a desired shape.

If a vacuum evaporator is used to form the dehydrated fruit, the fruit puree is first heated and vacuum dried to an appropriate water activity level, and then it is formed into a sheet that is further dried to a lower water activity level and cut into a desired shape.

Forming of the dehydrated fruit into a sheet, following either vacuum drying or grinding, can involve extrusion, compression, rolling, or stamping of the dehydrated fruit to form the sheet of dehydrated fruit. For example, in an extrusion process, a horn-shaped extrusion tool can be used where the puree is fed into the in-feed end and forced out of an elongated slit at the other end to create a sheet that can then be cut or further dried and cut.

Because dehydrated fruit can be tough to cut and chew, the method of the present disclosure provides for grinding of the dehydrated fruit into particles that are then reformed into a sheet. This provides tenderness and a softer texture that is more similar to a traditional flour-based crust and is more appropriate for cutting and chewing. Grinding can be done using a typical food or meat grinder where the dehydrated fruit is ground into particles ranging from 0.1 mm to 3.0 mm in overall diameter. For example, a Cuisinart high-speed chopper has been used to grind the dehydrated fruit into particles having an overall size of 3.0 mm.

After grinding, the particles can be further dried to a water activity level of 0.1 to 0.2 Aw to have a crunchy-like texture, which can then be ground again to a 0.1 mm to 0.3 mm particle size to form a cracker or graham cracker-like crust. Alternatively, after grinding, the particles are formed into a sheet using known processes as described above, i.e., extrusion, compression, rolling, or stamping. When extrusion is used, the particles are pressed into a typical horn shaped extruder with pressure ranging from 10 psi to 100 psi. A flat ribbon or sheet having a thickness in the range of 2 mm to 6 mm is extruded, which can then be cut into a circle or other shape for use as desired.

For example, the dehydrated fruit can be formed into at least one shell that surrounds a filling, the at least one shell consisting of the dehydrated fruit having a water activity level in the range of 0.4 to 0.9 Aw. The shell can be formed as a bottom layer and a top layer with the filling between the top and bottom layer, as in a conventional pie. Alternatively, the shell can be formed as a tube having a hollow interior to contain the filling.

The shell of dehydrated fruit can also be formed from multiple layers of sheets of dehydrated fruit, with each sheet having a thickness in the range of 0.1 mm to 1.0 mm. This will provide a flakiness to the shell or crust similar to that experienced with flour-based crusts. To enhance the flakiness, adjacent layers of sheets of the dehydrated fruit can have different water activity levels. In addition, layers of butter, a plastic shortening, lecithin, or an edible wax can be placed between each of the sheets of dehydrated fruit, similar to the way a croissant is formed. In one embodiment, 2 to 12 sheets or more sheets, or 4 to 8 sheets of dehydrated fruit are layered to form a crust or shell.

A 100% fruit pie can be made with 100% fruit crust using the techniques of the present disclosure. For example, the fruit pie will include a dehydrated fruit crust made from fruit that is dried to a water activity level preferably of 0.64 Aw, which has been ground into small nuggets of about 0.1 mm to 3.0 mm in diameter and then extruded into a pliable sheet that is cut to a diameter to the top and bottom crusts of the pie. The bottom crust, which can be about 2.0 mm to 6.0 mm thick, is formed of ground and reformed dehydrated fruit as described above that is placed on the bottom of the pie tin. The fruit filling is pasteurized, cooled, and then deposited into the pie shell, and a top crust (again preferably formed of the ground dehydrated fruit) is placed on top of the filling.

It is to be understood that a non-ground dehydrated fruit can also be used for the top and bottom crusts. During the extrusion process to form the sheets of dehydrated fruit, heat sensitive nutrients can be blended in the extruder or co-extruded with the fruit to minimize heat exposure. Ideally, the dehydrated fruit is made primarily from cull apples with other fruits added or natural fruit flavors or natural fruit colors or combinations of the foregoing can be used to change the taste to fit the pie flavor and the color (e.g., cherry, strawberry, peach, apricot, blackberry, raspberry, and the like).

The fruit fillings can be prepared using commercially available processes, or the following exemplar apple pie filling can be used, which utilizes apple concentrate, apple powder, apples, such as fresh Fuji apples that are peeled and cored and formed into 16 to 18 wedges.

TABLE 1
Apple

| Constituent | % by weight |
|---|---|
| Apple concentrate | 18.40 |
| Apple powder | 3.50 |
| Fresh Fuji apples, peeled & cored, | 78.10 |
| 16-18 wedges | |
| Total | 100.00 |

All of the foregoing ingredients are blended and then heated to approximately 180° F. and held at temperature for about 10 to 15 minutes. After heating, the ingredients are chilled and added to the fruit-based pie shell formed in accordance with the present disclosure. A top layer of the fruit-based pie shell is then placed over the pie, which can then be chilled. Heating of the final product is neither necessary nor recommended.

Similarly, a cherry pie filling can be prepared using grape juice concentrate, pectin, pear powder, and IQF frozen, whole sour cherries in the following proportions:

TABLE 2
Cherry

| Constituent | % by weight |
|---|---|
| Grape juice concentrate | 41.00 |
| Pectin | 0.70 |
| Pear powder | 5.50 |
| IQF Frozen, whole sour cherries | 52.80 |
| Total | 100.00 |

The ingredients are blended together and heated up to 170° F. and held at temperature for approximately three minutes to pasteurize the filling. Following heating, the ingredients are then chilled and added to the lower pie shell and the top layer of fruit-based crust can be added, if desired.

Because the filling has already been pasteurized, there is no need for cooking or baking of the finished pie. A fruit-based crust formed of multiple layers of sheets of dehydrated fruit can be made using multiple extruders that are stacked or concatenated. While rolling or compressing of the dehydrated fruit to form the sheets can be done, extrusion is a preferred method. Co-extrusion can also be done to form the multiple layers of dehydrated fruit sheets. Co-extrusion is also appropriate where the filling is extruded concurrently inside of an extrusion of the fruit-based shell in the form of a tube or noodle, which can then be cut and pinched off for sealing the filling inside of the tube.

The food products formed using the fruit-based crust of the present disclosure can be chilled, which will not result in hardening of the fruit-based crust because of the water activity, which drops the freezing point. In addition, the fruit-based products of the present disclosure will have a shelf life that is limited not to the crust but to the shelf life of the filling. The fruit-based products disclosed herein can be frozen, shipped out frozen, and then thawed at the store prior to sale.

While a preferred embodiment of the present disclosure has been described herein, it is to be understood that various changes, additions, and the like can be made without departing from the scope of the present disclosure. For example, the fruit-based crust of the present disclosure can be case-hardened to form a barrier to water. Alternatively, the crust could be coated with an oil or an edible wax, such as beeswax or carnauba wax, to protect the crust from moisture or water.

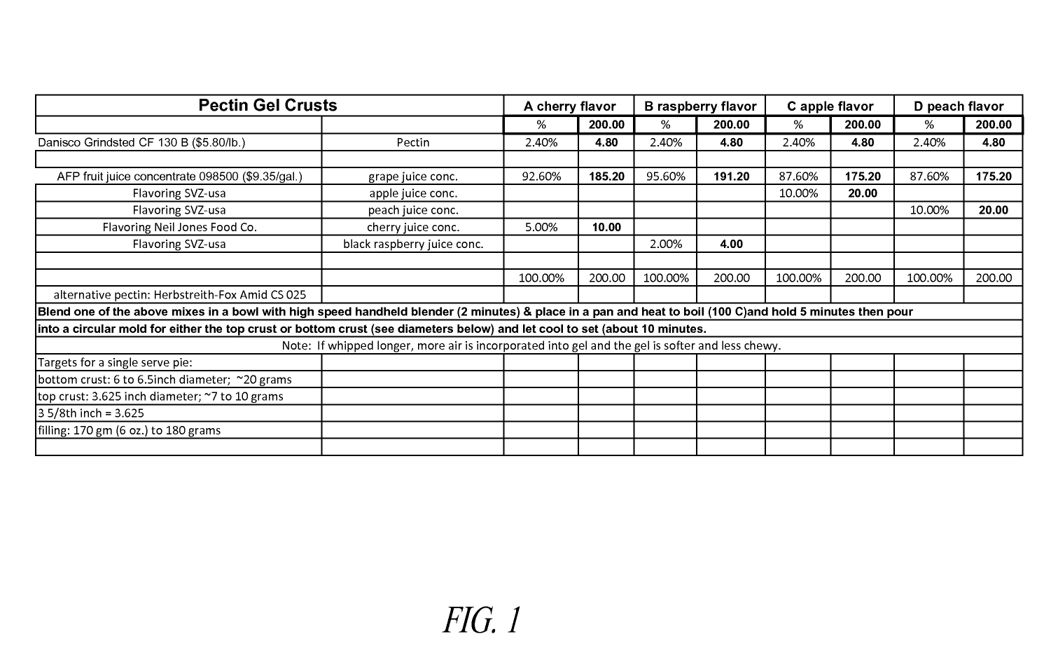

As another alternative, FIG. 1 illustrates several exemplar fruit-based shells products and exemplar methods for providing fruit-based shells as crusts.

As shown in FIG. 1, a fruit-based crust is ideally provided by mixing 2.4% pectin by weight, plus or minus 20%, with one or more fruit concentrates or flavoring. The plus or minus 20% of the pectin level means a range of 1.92% pectin to the desired level of 2.4% to a higher level of 2.88%. Generally, a lower level results in a softer texture and a higher level results in a stiffer texture. Pectin from commercially available sources may be used, but the pectin is preferably Danisco Grindsted CF 130 B. As an alternative, Herbstreith-Fox Amid CS 025 pectin can be used. Fruit juice concentrate from various commercially available sources can be used, but the fruit concentrate is preferably American Fruit Processors (AFP) fruit juice concentrate.

A second fruit concentrate is blended with the previously described juice concentrate as flavoring. Preferably, the Danisco Grindsted CF 130 B pectin, AFP fruit juice concentrate, and the second fruit concentrate flavoring is mixed at high speed for two minutes, boiled for five minutes, and poured into a mold. Mixing times and boiling times can be adjusted as desired.

Although any number of flavors can be obtained in accordance with the present disclosure, FIG. 1 lists cherry, raspberry, apple, and peach flavored exemplars. In accordance with the cherry-flavored exemplar, a fruit-based shell is provided from a mixture of 2.4% by weight pectin, 92.6% by weight AFP fruit juice concentrate, and 5% by weight cherry juice concentrate flavoring. Although the cherry juice concentrate may be used from any commercially available source, Neil Jones Food Co. cherry juice concentrate is ideally used. It will be appreciated that the concentrations of the AFP fruit juice concentrate and the cherry juice concentrate can be adjusted to alter taste.

In another exemplar, a black raspberry flavor crust is formed from a mixture of 2.4% by weight pectin, 95.6% by weight AFP fruit juice concentrate, and 2% by weight black raspberry juice concentrate flavoring. Although black raspberry juice concentrate can be obtained from any commercially available source, in the present exemplar, SVZ-USA black raspberry juice concentrate is preferred. It will be appreciated that the concentrations of the AFP fruit juice concentrate and the black raspberry juice concentrate can be adjusted to alter taste.

In another exemplar, an apple flavor crust is formed from a mixture of 2.4% by weight pectin, 87.6% by weight AFP fruit juice, and 10% by weight apple juice concentrate. Although apple juice concentrate can be obtained from any commercially available source, in the present exemplar, SVZ-USA apple juice is preferably used. It will be appreciated that the concentrations of the AFP fruit juice concentrate and the apple juice concentrate can be adjusted to alter taste.

In another embodiment, a peach flavor crust is formed from a mixture of 2.4% by weight pectin, 87.6% by weight AFP fruit juice concentrate, and 10% peach juice concentrate. Although the peach juice concentrate can be obtained from any commercially available source, in accordance with the present exemplar, SVZ-USA peach juice concentrate is used. It will be appreciated that the concentrations of the AFP fruit juice concentrate and the peach juice concentrate can be adjusted to alter taste.

More particularly, the American Fruit Processors (AFP) natural fruit sweetener L-FAC is used, which is a blend of pineapple syrup, apple concentrate, pear concentrate and peach concentrate. It is at 70.0 brix+/−0.5, 3.88 pH, and a density of 11.23 pounds per gallon. Also, white grape juice concentrate (de-ionized) is used, which is provided by Agro-Gold at 68 brix and pH of 3.30. Both of these sweeteners are very bland and the only ones found to be bland enough to use. All others are generally too tart, sour and have too intense flavor.

The flavorings which are used are also fruit concentrates (cherry, raspberry, apple and peach), having an intense flavor of the fruit from which they were derived.

As previously indicated, the above fruit-based shells and crusts can be used as a bottom shell, top shell, or shell layer, and can also be used as layered shells with traditional pie shells and shells from dehydrated fruit previously disclosed herein. An entirely fruit-based food product can be provided by filling the fruit-based crust with fruit-based fillings identified previously the present disclosure. Also, as previously indicated, the boiled mixture may be poured into a sheet that may be rolled during or after cooling. As can be appreciated, cooling can be accomplished by any number of means, including cooling at ambient temperatures and chilling. The rolled sheet may be filled with traditional pie and meat fillings or fruit-based fillings during or after cooling.

As further demonstrated by FIG. 1, a fruit-based crust or shell is ideally formed from a sufficient volume of the mixture of pectin, fruit juice concentrate, and fruit juice concentrate flavoring to form a single serving pie crust ranging from 3½ inches to 6.4 inches in diameter. Ideally, the thickness of the disclosed fruit-based crusts will correspond to a pie shell weight in the range of 3.5 grams and approximately 20 grams. It will be appreciated that various shell diameters, thicknesses, and caloric content can be obtained by adjusting the volume of the mixtures, the fruit concentrate, and the flavoring.

As will be readily appreciated from the foregoing alternative embodiment, no drying is required because the fruit concentrates (similar to honey or corn syrup) are already shelf stable given their low water activity (at or below 0.72 or 72% relative humidity—and more typically at 0.70 to 0.68 Aw). Not having to dry the final product is a terrific economic (no energy for drying) and labor savings. Hence, this process will produce the best flavored (very clean) and lowest priced fruit leathers. Ideally, the fruit juice concentrates are obtained from South America, making the costs very low and eliminating any need to hold fruit through the season. Other producers have to use apples from storage, convert into apple sauce, and then dry for 1 to 2 days, grind the dried leather, and reform them. In addition, these producers also bring in apple and pear juices, concentrate them using vacuum evaporators, which are expensive to operate, especially in the US, flavor them, and then extrude the blend on plastic sheets after which they are dried an additional amount of time. The present disclosed method and food product provides a much simpler process and better product.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A food product, comprising:
a filling; and
at least one shell surrounding the filling, the at least one shell formed of dehydrated fruit having a water activity in the range of 0.4 to 0.9 Aw.

2. The product of claim 1 wherein the bottom layer comprises dehydrated fruit ground into particles having a general diameter in the range of 0.1 mm to 0.3 mm and having a water activity level in the range of 0.1 to 0.2 Aw that are formed into a sheet.

3. The product of claim 1 wherein the dehydrated fruit has a water activity in the range of 0.6 to 0.75 Aw.

4. The product of claim 1 wherein the at least one shell comprises multiple layers of sheets of the dehydrated fruit, each sheet having a thickness in the range of 0.1 mm to 1.0 mm.

5. The product of claim 4, comprising a layer of butter between each of the sheets of the dehydrated fruit.

6. A method of producing a fruit product, comprising:
producing a puree of fruit;
drying the fruit to form a dehydrated fruit having a water activity level in the range of 0.4 to 0.9 Aw; and
forming the dehydrated fruit into a sheet having a thickness in the range of 2.0 mm to 6.0 mm.

7. The method of claim 6 wherein the air-dried sheets of dehydrated fruit are ground to a particle size in the range of 0.1 mm to 3 mm in diameter.

8. The method of claim 6 wherein the drying of the fruit puree to form the dehydrated fruit comprises heating and vacuum drying the fruit puree to a water activity level in the range of 0.4 to 0.9 Aw.

9. The method of claim 7 wherein the dehydrated fruit is dried to a water activity level of 0.1 to 0.2 Aw prior to grinding to form crunchy dehydrated fruit particles.

10. A fruit-based crust formed of dehydrated fruit having a water activity level in the range of 0.4 to 0.9 Aw.

11. The crust of claim 10 wherein the dehydrated fruit comprises ground dehydrated fruit particles, each particle having an overall diameter in the range of 0.1 mm to 3.0 mm.

12. The crust of claim 10 wherein the dehydrated fruit comprises a fruit puree that has been dried using one from among air-drying and heated vacuum drying.

13. The crust of claim 10 wherein the crust comprises multiple layers of sheets of dehydrated fruit and adjacent sheets of the dehydrated fruit have different water activity levels to provide a flakiness to the crust.

14. The crust of claim 13, further comprising a layer of butter formed between adjacent sheets of dehydrated fruit.

15. A method of producing a food product, comprising:
providing a mixture of pectin and at least two fruit juice concentrates, the pectin comprising between 1.9% and 2.9% by weight of the mixture, a first fruit juice concentrate comprising 86% to 96% by weight of the mixture and the remainder of the mixture comprising a first juice concentrate flavoring comprising 2.0% to 10% by weight of the mixture;
boiling the mixture into a boiled mixture;
delivering the boiled mixture into a receptacle; and
cooling the boiled mixture to ambient temperature.

16. The method of claim 15, wherein the mixture is blended for a period of time in the range of 2 and 3 minutes.

17. The method of claim 15, wherein the mixture is boiled for a period of time in the range of 3 to 7 minutes.

18. A food product, comprising:
a boiled and cooled mixture, the mixture comprising:
1.9% to 2.9% pectin by weight;
a fruit juice concentrate flavoring comprising 2% to 10% by weight; and
a second fruit juice concentrates comprising 86% to 96% by weight.

19. The food product of claim 18, wherein the fruit juice concentrate flavoring comprises apple juice concentrate, peach juice concentrate, cherry juice concentrate, or black raspberry juice concentrate.
